(19) United States
(12) Patent Application Publication
(10) Pub. No.: US 2023/0412517 A1
(43) Pub. Date: Dec. 21, 2023

(54) SYSTEM AND METHOD FOR SIMULTANEOUS PACKET PROCESSING THROUGH MULTIPLE CONTAINERS

(71) Applicant: WINS Co., Ltd., Seongnam-si (KR)

(72) Inventors: Gu Min NAM, Anyang-si (KR); Hyoung Shick KIM, Suwon-si (KR)

(21) Appl. No.: 18/315,447

(22) Filed: May 10, 2023

(30) Foreign Application Priority Data
Jun. 10, 2022 (KR) 10-2022-0070988

(51) Int. Cl. H04L 47/283; H04L 47/2483

(52) U.S. Cl. CPC H04L 47/283; H04L 47/2483

(57) ABSTRACT

A simultaneous packet processing system through multiple containers according to an embodiment of the disclosure includes a controller container configured to generate metadata including reference information on an input packet, generate a bucket, and store a plurality of pieces of metadata in the bucket; a shared memory in which the bucket is generated; and a plurality of worker containers configured to include each of modules constituting an application, wherein each of the plurality of worker containers processes the packet by referring to the metadata in the bucket.

### CROSS-REFERENCE TO RELATED APPLICATION(S)

This application is based on and claims priority under 35 U.S.C. 119 to Korean Patent Application No. 10-2022-0070988, filed on Jun. 10, 2022, in the Korean Intellectual Property Office, the disclosure of which is herein incorporated by reference in its entirety.

### BACKGROUND OF THE INVENTION

### 1. Field of the Invention

The disclosure relates to a system and a method for simultaneous packet processing through multiple containers.

### 2. Description of the Prior Art

Mobile edge computing (MEC), one of the technologies that achieve 5G services with characteristics such as ultra-low latency, ultra-high speed, and ultra-connectivity, is an edge computing technology that provides services by building a system at the edge close to users.

MEC is based on software defined network (SDN) for network slicing and network functions virtualization (NFV) that virtualizes network equipment.

The fact that SDN separates control and data to apply network slicing technology to NFV may provide flexibility capable of providing services tailored to traffic characteristics. However, network slicing alone may not be able to satisfy the traffic throughput and delay time required to meet the service level that VNF should provide.

Therefore, for high-speed packet processing, there is a need for a technology capable of increasing processing speed and reducing delay time by horizontally dividing a vertical packet processing structure processed by one application.

### PRIOR ART LITERATURE

### Patent Literature

(Patent Document 1) KR 10-2022-0061500 A

### SUMMARY OF THE INVENTION

When packets received through network slicing in MEC are processed in one container, the required packet processing delay time may not be satisfied as the number of packet processing steps increases and becomes more complex.

Therefore, it is necessary to configure a single process by separating the single process into a plurality of containers that perform several segmented processes. However, when each divided container simultaneously accesses a packet, problems such as a processing time delay loss due to processing order control and packet copying or locking may occur.

As a method to solve this problem, the disclosure proposes a method in which a set of series of packets is simultaneously transmitted to a plurality of containers in a zero-copy technique and each container processes the packets received in parallel based on metadata including information referring to each packet included in a shared memory.

The disclosure has been made in order to solve the above-mentioned problems in the prior art, and an aspect of the disclosure is to provide a simultaneous packet processing system and method through multiple containers in which, for high-speed packet processing, a vertical packet processing structure processed by one application may be horizontally divided to increase the processing speed and reduce the delay time, and the multiple containers may simultaneously process packets in parallel by separating the entire application into a plurality of containers of a single functional unit to increase throughput and reduce delay time.

In accordance with an aspect of the disclosure, there is provided a simultaneous packet processing system through multiple containers, including a controller container configured to generate metadata including reference information on an input packet, generate a bucket, and store a plurality of pieces of metadata in the bucket; a shared memory in which the bucket is generated; and a plurality of worker containers configured to include each of modules constituting an application, wherein each of the plurality of worker containers processes the packet by referring to the metadata in the bucket.

In the simultaneous packet processing system through multiple containers according to an embodiment of the disclosure, the metadata may include a packet processing status bitmap indicating whether the corresponding worker container processes the packet, each bit of the packet processing status bitmap may indicate a packet processing completion status or a packet non-processing status of the corresponding worker container, the worker container having processed the packet may set the corresponding bit of the corresponding packet processing status bitmap to a packet processing completion status, and the worker container having processed the packet may set, when a specific worker container does not need to process the packet, a bit corresponding to the specific worker container from the packet processing status bitmap for the corresponding packet to the packet processing completion status.

In addition, in the simultaneous packet processing system through multiple containers according to an embodiment of the disclosure, each of the plurality of worker containers may include a unique identification number (WID) of the worker container; and a prerequisite worker container bitmask (PID) indicating that the corresponding worker container can process the packet after the corresponding packet is processed by the specific worker container.

In addition, in the simultaneous packet processing system through multiple containers according to an embodiment of the disclosure, each of the worker containers may simultaneously access the shared memory to refer to the bucket, and confirm the packet to be processed by comparing the prerequisite worker container bitmask (PID) of each worker container with the packet processing status bitmap in the metadata of the bucket.

In addition, in the simultaneous packet processing system through multiple containers according to an embodiment of the disclosure, a packet processing completion bitmap indicating whether each packet referred to by the metadata included in the bucket is completely processed may be added to each bucket, each bit of the packet processing completion bitmap may indicate whether the packet referred to by the metadata included in the corresponding bucket is completely processed by all the worker containers, and the worker container that has confirmed that all bits of the packet processing status bitmap are set to the packet processing completion status may set the corresponding bit of the packet processing completion bitmap to the packet processing completion status.

In addition, in the simultaneous packet processing system through multiple containers according to an embodiment of the disclosure, when all bits of the packet processing completion bitmap of the bucket are set to the packet processing completion state, the controller container may empty or delete the bucket, and the controller container may output or discard packets referred to by the metadata in the bucket according to a packet processing policy by referring to the metadata of the corresponding bucket in order to empty the corresponding bucket.

In addition, in the simultaneous packet processing system through multiple containers according to an embodiment of the disclosure, the metadata may further include a packet pointer configured to indicate a location of a packet stored in a storage space of a network interface card through which packets are input/output; and user data including information shared with other containers during packet processing, including additional processing results for the packet.

In addition, in the simultaneous packet processing system through multiple containers according to an embodiment of the disclosure, when the number of buckets to store the generated metadata is insufficient, the controller container may generate a new bucket for storing the generated metadata in the shared memory.

In accordance with another aspect of the disclosure, there is provided a simultaneous packet processing method through multiple containers including (A) by a controller container, generating metadata including reference information on an input packet; (B) by the controller container, generating a bucket in a shared memory and storing a plurality of pieces of metadata in the bucket; and (C) by each of a plurality of worker containers including each of modules constituting an application, processing the packet by referring to the metadata in the bucket.

In the simultaneous packet processing method through multiple containers according to an embodiment of the disclosure, the metadata may include a packet processing status bitmap indicating whether the corresponding worker container processes the packet, each bit of the packet processing status bitmap may indicate a packet processing completion status or a packet non-processing status of the corresponding worker container, the worker container having processed the packet may set the corresponding bit of the corresponding packet processing status bitmap to the packet processing completion status, and the worker container having processed the packet may set, when a specific worker container does not need to process the packet, a bit corresponding to the specific worker container from the packet processing status bitmap for the corresponding packet to the packet processing completion status.

In addition, in the simultaneous packet processing method through multiple containers according to an embodiment of the disclosure, each of the plurality of worker containers may include a unique identification number (WID) of the worker container; and a prerequisite worker container bitmask (PID) indicating that the corresponding worker container can process the packet after the corresponding packet is processed by the specific worker container.

In addition, in the simultaneous packet processing method through multiple containers according to an embodiment of the disclosure, each of the worker containers may simultaneously access the shared memory to refer to the bucket, and confirm the packet to be processed by comparing the prerequisite worker container bitmask (PID) of each worker container with the packet processing status bitmap in the metadata of the bucket.

In addition, in the simultaneous packet processing method through multiple containers according to an embodiment of the disclosure, a packet processing completion bitmap indicating whether each packet referred to by the metadata included in the bucket is completely processed may be added to each bucket, each bit of the packet processing completion bitmap may indicate whether the packet referred to by the metadata included in the corresponding bucket is completely processed by all the worker containers, and the worker container that has confirmed that all bits of the packet processing status bitmap are set to the packet processing completion status may set the corresponding bit of the packet processing completion bitmap to the packet processing completion status.

In addition, in the simultaneous packet processing method through multiple containers according to an embodiment of the disclosure, when all bits of the packet processing completion bitmap of the bucket are set to the packet processing completion state, the controller container may empty or delete the bucket, and the controller container may output or discard packets referred to by the metadata in the bucket according to a packet processing policy by referring to the metadata of the corresponding bucket in order to empty the corresponding bucket.

In addition, in the simultaneous packet processing method through multiple containers according to an embodiment of the disclosure, the metadata may further include a packet pointer configured to indicate a location of a packet stored in a storage space of a network interface card through which packets are input/output; and user data including information shared with other containers during packet processing, including additional processing results for the packet.

In addition, in the simultaneous packet processing method through multiple containers according to an embodiment of the disclosure, when the number of buckets to store the generated metadata is insufficient, the controller container may generate a new bucket for storing the generated metadata in the shared memory.

According to the simultaneous packet processing system and method through multiple containers according to an embodiment of the disclosure, the entire application may be separated into multiple containers in a single functional unit, a set of series of packets may be simultaneously transmitted to a plurality of containers in a zero-copy technique, and each container may simultaneously process packets received in parallel based on metadata including information referring to each packet included in a shared memory, thereby increasing the processing speed and throughput to reduce delay time.

### BRIEF DESCRIPTION OF THE DRAWINGS

The above and other aspects, features and advantages of the disclosure will be more apparent from the following detailed description taken in conjunction with the accompanying drawings, in which:

FIG. 1 is a conceptual diagram illustrating a simultaneous packet processing system through multiple containers according to an embodiment of the disclosure.

FIG. 2 is a system configuration diagram illustrating a simultaneous packet processing system through multiple containers according to an embodiment of the disclosure.

FIGS. 3A to 3C are diagrams illustrating a packet processing status bitmap.

FIGS. 4A and 4B are diagrams illustrating a packet processing completion bitmap.

FIG. 5 is a flowchart illustrating a simultaneous packet processing method through multiple containers according to an embodiment of the disclosure.

FIG. 6 is a flowchart illustrating packet processing of a controller container.

FIG. 7 is a flowchart illustrating packet processing of a worker container.

### DETAILED DESCRIPTION OF THE EXEMPLARY EMBODIMENTS

The objects, specific advantages, and novel features of the disclosure will become more apparent from the following detailed description taken in conjunction with the accompanying drawings and preferred embodiments.

The terms and words which are used in the present specification and the appended claims should not be construed as being confined to common meanings or dictionary meanings but be construed as meanings and concepts matching with the technical spirit of the disclosure based on the principle that an inventor can properly define the concept of a term to describe his/her invention in the best fashion.

In the specification, in adding reference numerals to components throughout the drawings, it is to be noted that like reference numerals designate like components even though components are shown in different drawings.

In addition, the terms “first”, “second”, “one surface”, “the other surface” and so on are used to distinguish one element from another element, and the elements are not defined by the above terms.

In describing the disclosure, a detailed description of related known functions or configurations will be omitted so as not to obscure the gist of the disclosure.

Hereinafter, preferred embodiments of the disclosure will be described in detail with reference to the accompanying drawings.

In a simultaneous packet processing system and method through multiple containers according to an embodiment of the disclosure, packet reference information may be simultaneously transmitted to a plurality of containers in a zero-copy technique for a set of series of packets, and each container may process the packets by referring to the packet reference information received in parallel.

In addition, in the simultaneous packet processing system and method through multiple containers according to an embodiment of the disclosure, each container may confirm a target to be processed through metadata including information referring to a packet that each container can process.

In addition, in the simultaneous packet processing system and method through multiple containers according to an embodiment of the disclosure, by separating one application into a plurality of containers for high-speed packet processing, a plurality of containers may simultaneously process packets in parallel, thereby increasing the throughput and reducing the delay time.

In addition, in the simultaneous packet processing system and method through multiple containers according to an embodiment of the disclosure, rather than a structure that sequentially processes packets in one application, each module constituting the application may be configured as a container, and a bucket including a plurality of pieces of metadata including reference information indicating each packet may be transmitted to each container through a shared memory, thereby processing the packets using a distribution technique.

In addition, in the simultaneous packet processing system and method through multiple containers according to an embodiment of the disclosure, during packet processing using a distribution technique, the processing priorities of the packets may be determined to process the packets.

In addition, the simultaneous packet processing system through multiple containers according to an embodiment of the disclosure may include a plurality of worker containers configured to perform metadata processing, transmission/reception packet bucket processing, and function-specific packet processing, a controller container configured to perform worker container control, and a shared memory.

In an embodiment of the disclosure, a container refers to isolation technologies such as Linux processes or networks, metadata may be used for managing a packet pointer that refers to or indicates packets to manage the packets based on a shared memory, and additional information, and a bucket may be used for storing a plurality of pieces of metadata and managing the metadata in units of bundles.

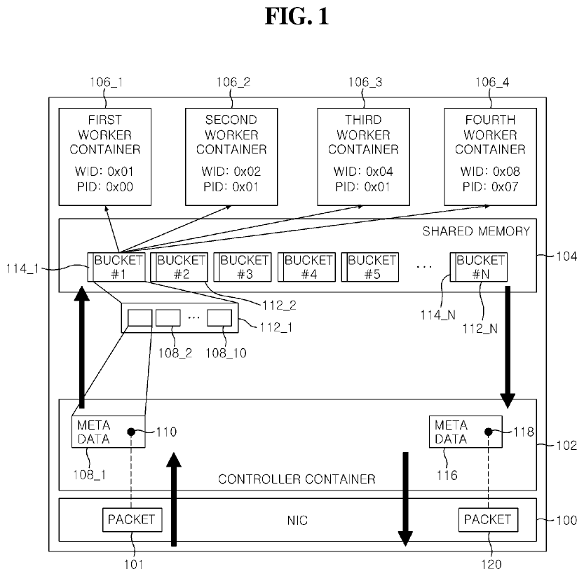

A simultaneous packet processing system through multiple containers according to an embodiment of the disclosure shown in FIG. 1 may include a controller container 102 configured to generate metadata 108_1 including a packet pointer 110, which is reference information for a packet 101 input and stored in a network interface card (MC) 100, to generate a bucket 112_1 including the metadata 108_1, and to store a plurality of pieces of metadata 108_1 to 108_10 in the bucket 112_1, a shared memory 104 in which buckets 112_1 to 112_N are generated, and a plurality of worker containers 106_1 to 106_4 configured to include each of modules constituting an application.

Each of the plurality of worker containers 106_1 to 106_4 may process the packet 101 by referring to the metadata 108_1 to 108_10.

In FIG. 1, Reference number 116 denotes metadata, reference number 118 denotes a packet pointer, and reference number 120 denotes a packet indicated by the packet pointer 118.

In an embodiment of the disclosure, it is assumed that one bucket 112_1 stores 10 pieces of metadata. However, the embodiment of the disclosure is not limited thereto, and one bucket 112_1 may store a smaller or larger number of meta data.

In FIG. 1, reference numerals 114_1 to 114_N denote packet processing completion bitmaps added to the buckets 112_1 to 112_N, respectively.

In the simultaneous packet processing system through multiple containers according to an embodiment of the disclosure, by dividing metadata including information referring to a large number of packets in units of buckets, the metadata may be simultaneously processed in a container-based process horizontally divided for each function, thereby increasing the processing performance for all the packets and reducing the packet delay time.

The controller container 102 may generate metadata 108_1 to 108_10 including packet reference information 110 with respect to each of the packets 101 that are input and stored in the MC 100 or a network device so that all the worker containers 106_1 to 106_4 can simultaneously have a read-access to the corresponding packets, and store and manage the generated metadata 108_1 to 108_10 in the buckets 112_1 to 112_N generated in the shared memory 104.

All the worker containers 106_1 to 106_4 may confirm target packets through the metadata 108_1 to 108_10 and store packet processing results in the corresponding metadata 108_1 to 108_10.

In the simultaneous packet processing system through multiple containers according to an embodiment of the disclosure, metadata, bucket information, and worker container information may be generated.

The metadata 108_1 may include a packet pointer 110, which is packet reference information indicating the location of the packet 101 which is input and stored in the MC 100, user data including information shared with other containers during packet processing, including additional processing results for the packet 101, and a packet processing status bitmap indicating whether the corresponding worker container has processed the packet.

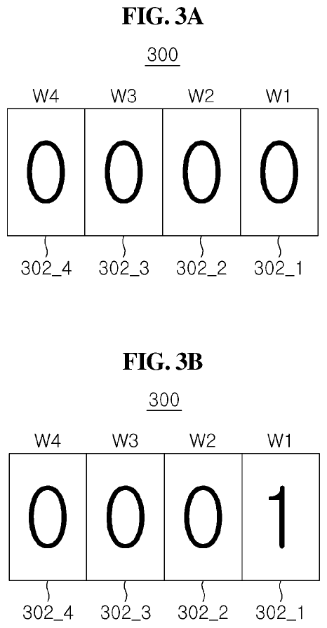

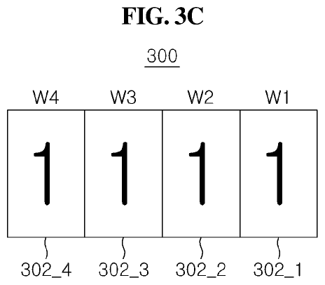

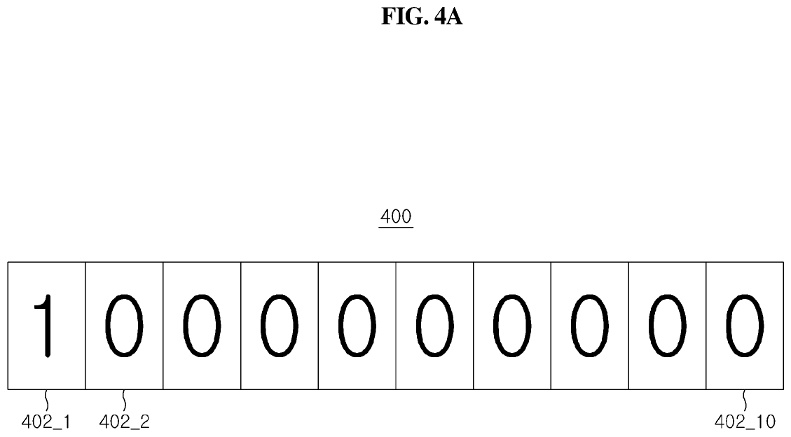

Referring to FIG. 3A, for example, each bit 302_1 to 302_4 of the packet processing status bitmap 300 may indicate a packet processing completion status or a packet non-processing status of the corresponding worker container. Here, the worker container having processed the packet may set the corresponding bit (corresponding bit of 302_1 to 302_4) of the packet processing status bitmap 300 to the packet processing completion status, and set the corresponding bit of the processing status bitmap 300 to the packet processing completion status when there is a worker container that does not need to be processed according to the characteristics of the packet. For example, in an embodiment of the disclosure, the packet processing completion status may be set to 1, and the packet unprocessed status may be set to 0.

The bucket information may include a packet processing completion bitmap indicating whether processing of the packet indicated by each metadata included in the bucket has been completed, and a bucket size.

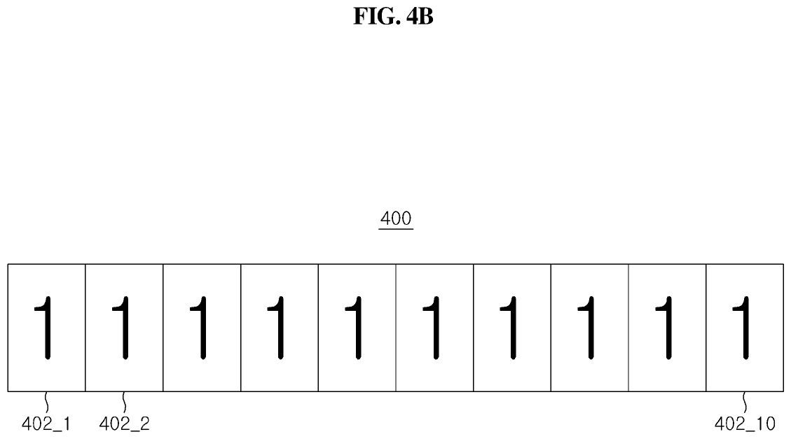

Referring to FIG. 4A, for example, each bit 402_1 to 402_10 of the packet processing completion bitmap 400 may indicate whether processing of the packet indicated by corresponding metadata in the corresponding bucket has been completed. In an embodiment of the disclosure, for example, it is assumed that one bucket 112_1 can store 10 pieces of metadata. However, the disclosure is not limited thereto and one bucket 112_1 may store a smaller or larger number of metadata.

Meanwhile, when it is confirmed that all the bits 302_1 to 302_4 of the packet processing status bitmap 300 are set to 1 after the worker container completes packet processing and set the corresponding bit of the packet processing status bitmap 300 of FIGS. 3 to 1, the worker container confirming that all the bits 302_1 to 302_4 of the packet processing status bitmap 300 are set to 1 may set the corresponding bit of the packet processing completion bitmap 400 to the packet processing completion state.

For example, as shown in FIG. 3C, when a first worker container 106_1 confirms that all the bits 302_1 to 302_4 of the packet processing status bitmap 300 are set to 1 after the first worker container 106_1 completes processing of the packet 101 indicated by the packet pointer 110 included in a first metadata 108_1 in a first bucket 112_1 and sets the corresponding bit 302_1 of the packet processing status bitmap 300 to 1, the first worker container 106_1 confirming that all the bits 302_1 to 302_4 of the packet processing status bitmap 300 are set to 1 may set the corresponding bit 402_1 of the packet processing completion bitmap 400 to 1 indicating the packet processing completion status, as shown in FIG. 4A.

That is, the status of the packet processing completion bitmap 400 shown in FIG. 4A may indicate that processing of the packet 101 indicated by the packet pointer 110 included in the first metadata 108_1 in the first bucket 112_1 that is the first bucket has been completed.

The worker container information may include a unique identification number (WID) of the worker container, and a prerequisite worker container bitmask (PID) indicating that the corresponding worker container can process the packet after the corresponding packet is processed by a specific worker container.

Referring again to FIG. 1, the controller container 102 may generate the metadata 108_1 including reference information and additional information on the packet 101 that is input by processing input/output of the packet pointer, generate the buckets 112_1 to 112_N in the shared memory 104, and may store the plurality of pieces of metadata 108_1 to 108_10 in the bucket 112_1.

The controller container 102 may generate the plurality of buckets 112_1 to 112_N in the shared memory 104.

The metadata 108_1 may be managed as a bundle of metadata called a bucket. The controller container 102 may manage the metadata in units of buckets.

When the buckets are needed up to a certain number, the bucket may be maintained at a certain size by additionally generating the buckets or dropping the metadata including information referring to the packet. The generation and deletion of the buckets may be performed by the controller container 102, and as an example, as shown in FIG. 4B, when each bit 402_1 to 402_10 of the packet processing completion bitmap of the bucket is all set to 1, this indicates that processing of all packets indicated by all metadata in the bucket is complete, so that the corresponding bucket may be emptied and deleted.

When the processing of all the packets indicated by all metadata in the bucket has been completed, the controller container 102 may output or discard the corresponding packets according to a packet processing policy (accept or drop) by referring to the metadata in the bucket, and then empty the metadata in the bucket.

In this manner, when it is confirmed that the processing of the packet indicated by all metadata 108_1 to 108_10 in the bucket 112_1 has been completed, by referring to the packet processing completion bitmap 114_1 or 400 of the first bucket 112_1 that is the first bucket, the controller container 102 may output or discard the packet according to the packet processing policy.

The controller container 102 may provide, to each worker container 106_1 to 106_4, a worker container unique identification number (WID) at the time of initial execution and a prerequisite worker container bitmask (PID) indicating that the corresponding worker container can process the packet after the corresponding packet has been processed by a specific worker container.

There is one or more worker containers, and all the worker containers 106_1 to 106_4 may confirm whether they can process the packet by referring to the metadata in the first bucket 112_1, and process the packet when the packet is a target packet and then record the packet processing results in the metadata 108.

In an embodiment of the disclosure, for example, it is exemplarily assumed that four worker containers 106_1 to 106_4 exist, but the disclosure is not limited thereto, and fewer or more worker containers may exist.

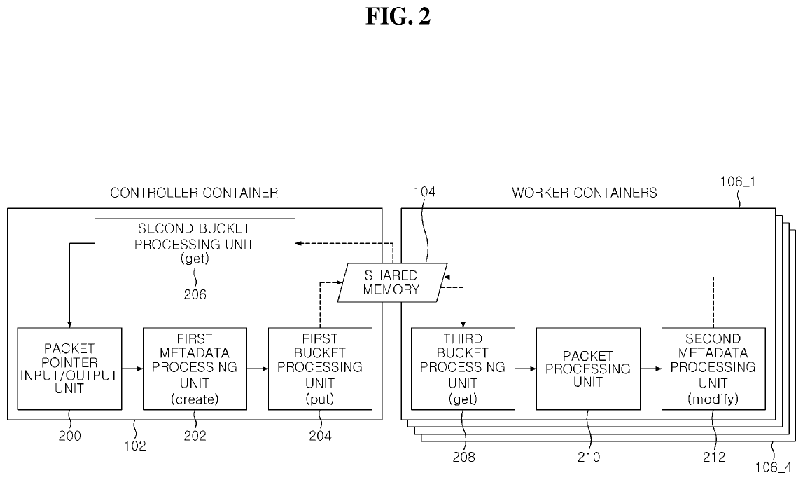

FIG. 2 is a system configuration diagram illustrating a simultaneous packet processing system through multiple containers according to an embodiment of the disclosure.

Referring to FIG. 2, the controller container 102 may include a packet pointer input/output unit 200 in charge of input/output of a packet or a packet pointer, a first metadata processing unit 202, a first bucket processing unit 202, and a second bucket processing unit 206.

Each of the first to fourth worker containers 106_1 to 106_4 may include a third bucket processing unit 208, a packet processing unit 210, and a second metadata processing unit 212.

The first metadata processor 202 in the controller container 102 may generate the metadata 108_1 for managing reference and additional information on the input packet 101.

The metadata 108_1 may include a packet processing status bitmap 300 as shown in FIG. 3A. Each bit of the packet processing status bitmap 300 may correspond to each of the first to fourth worker containers 106_1 to 106_4.

For example, the first worker container 106_1 may correspond to a first bit 302_1, the second worker container 106_2 may correspond to a second bit 302_2, the third worker container 106_3 may correspond to a third bit 302_3, and the fourth worker container 106_4 may correspond to a fourth bit 302_4.

Meanwhile, the second metadata processing unit 212 in each worker container 106_1 to 106_4 may reflect the packet processing result to the metadata 108_1, and change user data or the packet processing status bitmap 300 so that the packet can be processed in another worker container. The user data may include information shared with other containers during packet processing, including additional processing results.

For example, the second metadata processing unit 212 may set the corresponding bit of the packet processing status bitmap 300 to 1 when packet processing is completed or needed.

For example, as shown in FIG. 3B, when the second metadata processing unit 212 present in the first worker container 106_1 completes packet processing, in order to reflect the packet processing result to the metadata 108_1, the second metadata processing unit 212 present in the first worker container 106_1 may set the corresponding bit 302_1 to 1 in the packet processing status bitmap 300 present in the metadata 108_1.

The first bucket processing unit 204 in the controller container 102 may store the generated metadata 108_1 in the bucket 112_1 generated in the shared memory 104. When there is no free space in the bucket, the first bucket processing unit 204 may generate a new bucket in the shared memory 104 and then store the metadata 108_1 in the newly generated bucket.

The third bucket processing unit 208 present in each of the worker containers 106_1 to 106_4 may sequentially access the first metadata 108_1 present in the first bucket 112_1 of the shared memory 104 to confirm whether the packet indicated by the first metadata 108_1 is a packet to be processed of the corresponding container, and transmit the packet to the packet processing unit 210 when the packet is the packet to be processed.

The second bucket processing unit 206 in the controller container 102 may confirm whether processing of all the packets indicated by all metadata 108_1 to 108_10 of the first bucket 112_1 has been completed, and empty and delete the bucket 112_1 when the processing of all the packets has been completed.

As shown in FIGS. 4A and 4B, the second bucket processing unit 206 in the controller container 102 may identify each bit of the packet processing completion bitmaps 114_1 to 114_N of FIG. 1 or 400 of FIG. 4 added to each bucket 112_1 to 112_N to confirm whether processing of all the packets indicated by all metadata 108_1 to 108_10 in the bucket 112_1 has been completed.

For example, when a total of 10 pieces of metadata 108_1 to 108_10 exist in one bucket 112_1, as shown in FIG. 4A, the packet processing completion bitmap 400 may be composed of a total of 10 bits.

For example, the first bit 402_1 may correspond to a packet indicated by the first metadata 108_1 in the bucket 112_1, and the tenth bit 402_10 may correspond to a packet indicated by the tenth metadata 108_10 in the bucket 112_1.

Accordingly, as shown in FIG. 4B, when the first bit 402_1 to the tenth bit 402_10 are all set to 1, the second bucket processing unit 206 in the controller container 102 may confirm that processing of a total of 10 packets indicated by 10 pieces of metadata 108_1 to 108_10 in the bucket 112_1 has been completed, and empty and delete the bucket 112_1.

On the other hand, when the packet pointers included in the metadata 108_1 to 108_10 in the bucket 112_1 are transmitted to the packet pointer input/output unit 200 while the bucket 112_1 is emptied, or when the packet is required to be deleted, the second bucket processing unit 206 in the controller container 102 may delete the corresponding packets based on the packet pointers included in the metadata 108_1 to 108_10 in the bucket 112_1.

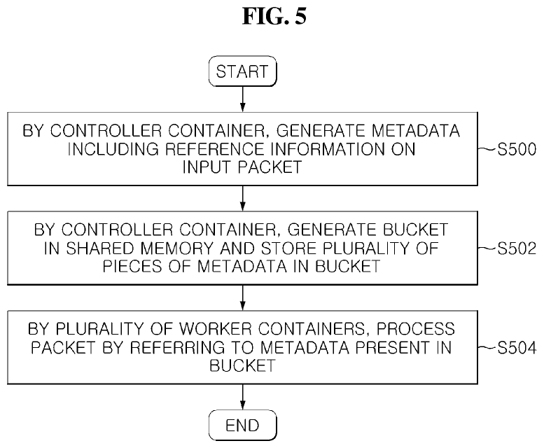

FIG. 5 is a flowchart illustrating a simultaneous packet processing method through multiple containers according to an embodiment of the disclosure.

Referring to FIG. 5, in operation S500, the controller container 102 may generate metadata 108_1 including reference information 110 for the input packet 101.

In operation S502, the controller container 102 may generate a bucket 112_1 in the shared memory 104 and store a plurality of metadata 108_1 to 108_10 indicating a plurality of packets in the bucket 112_1.

Each of first to fourth worker containers 106_1 to 106_4 including each of modules constituting an application may process the packet 101 by referring to the metadata 108_1 to 108_10 in the bucket 112_1.

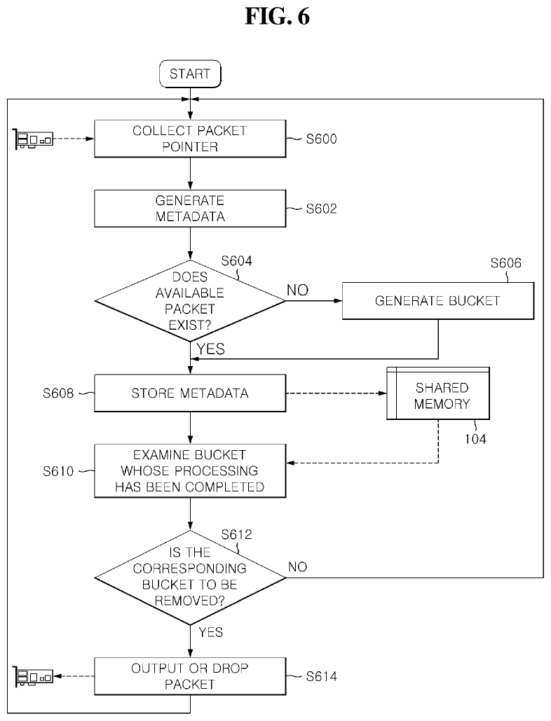

FIG. 6 is a flowchart illustrating packet processing of a controller container 102.

Referring to FIGS. 1 and 6, in operation S600, the controller container 102 may collect the packet pointer 110, which is packet reference information indicating the packet 101 input and stored in an MC 100 or a network device, and generate metadata 108_1 for managing the packet 101 in operation S602.

The metadata 108_1 generated by the controller container 102 may include the packet pointer 110 for the packet 101, user data, and a packet processing status bitmap (300 in FIG. 3).

Additional processing results for the packet 101 may be stored in the user data and can be referred to in other containers. At this time, the user data has separated data areas, so that the user data is not processed redundantly even if all containers process the user data simultaneously.

The packet processing status bitmap 300 in FIG. 3A may be set by the worker container that processed the packet, and the entire size of the packet processing status bitmap 300 may be equal to the number of work containers.

In an embodiment of the disclosure, since four worker containers 106_1 to 106_4 exist, the packet processing status bitmap 300 has a size of 4 bits, as shown in FIG. 3A.

Each bit of the packet processing status bitmap 300 may correspond to each of the first to fourth worker containers 106_1 to 106_4.

For example, the first worker container 106_1 may correspond to the first bit 302_1, the second worker container 106_2 may correspond to the second bit 302_2, the third worker container 106_3 may correspond to the third bit 302_3, and the fourth worker container 106_4 may correspond to the fourth bit 302_4.

Each bit 302_1 to 302_4 of the packet processing status bitmap 300 may indicate a packet processing completion status or a packet non-processing status of the corresponding worker container. In an embodiment of the disclosure, the packet processing completion status may be set to 1, and the packet non-processed status may be set to 0.

The worker container having processed the packet may set the corresponding bit of the packet processing status bitmap 300 to the packet processing completion status in the future, and set, when there is a worker container that does not need to process the packet according to the characteristics of the packet, bits corresponding to the worker container that does not need to process the packet among the bits 302_1 to 302_4 of the processing status bitmap 300 to the packet processing completion status.

In operation S604, the controller container 102 may determine whether an available bucket exists, and generate the bucket 112_1 in operation S606 when there is no available bucket.

When there is the available bucket, in operation S608, the controller container 102 may store the metadata 108_1 in the bucket 112_1. In the above, the bucket 112_1 is a storage space allocated to the shared memory 104 and may store a plurality of metadata 108_1 to 108_10. That is, the bucket 112_1 is for managing metadata in units of bundles.

In operation S610, the controller container 102 may examine a bucket whose processing has been completed.

In this operation, the controller container 102 may identify the packet processing completion bitmap 114_1 to 114_N or 400 indicating whether processing of each packet indicated by each packet pointer of the metadata 108_1 to 108_10 included in the bucket 112_1 has been completed, thereby examining the bucket in which packet processing has been completed.

In operation S612, the controller container 102 may determine whether the bucket is a bucket to be removed.

Since each bit of the packet processing completion bitmap 400 indicates whether processing of the packet corresponding to the packet pointer of the metadata in the corresponding bucket has been completed, the controller container 102, as shown in FIGS. 4A and 4B, may determine whether to remove the bucket by identifying each bit 402_1 to 402_10 of the packet processing completion bitmap 114_1 to 114_N of FIG. 1 and 400 of FIGS. 4A and 4B added to each bucket 112_1 to 112_N.

For example, as shown in FIG. 4B, when all bits 402_1 to 402_10 of the packet processing completion bitmap 400 are set to 1 so that the corresponding bucket 112_1 is determined to be a bucket to be removed because processing of the packets indicated by the respective packet pointers of all metadata 108_1 to 108_10 in the bucket 112_1 has been completed, in operation S614, the controller container 102 may empty the bucket 112_1 and output the packet pointer of the metadata in the bucket 112_1 to the MC 100, or delete the packets indicated by the packet pointer of the metadata in the bucket 112_1.

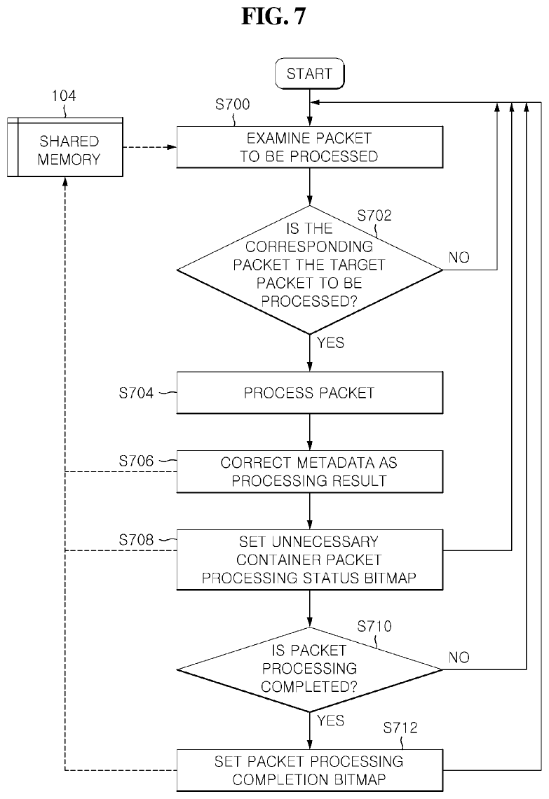

FIG. 7 is a flowchart illustrating packet processing of worker containers 106_1 to 106_4.

Referring to FIGS. 1 and 7, in operation S700, all worker containers 106_1 to 106_4 may simultaneously access the shared memory 104 to refer to the first bucket 112_1, which is the first bucket, thereby examining the packet to be processed.

In operation S702, each of the worker containers 106_1 to 106_4 may compare a packet processing status bitmap (e.g., 300 of FIG. 3A) in the metadata 108_1 of the first bucket 112_1 with its own prerequisite worker container bitmask (HD) to confirm whether the corresponding packet is the target packet to be processed by each of the worker containers 106_1 to 106_4.

In operation S704, each of the worker containers 106_1 to 106_4 may process the corresponding packet when the corresponding packet is a packet in a condition that each of the worker containers 106_1 to 106_4 can process.

Referring to FIG. 1, for example, the HD of the first worker container 106_1 is 0x00, the HD of the second worker container 106_2 is 0x01, the HD of the third worker container 106_3 is 0x01, and the HD of the fourth worker container 106_4 is 0x07.

Since the HD of the current first worker container 106_1 is the same as the packet processing status bitmap (e.g., 300 of FIG. 3A) in the metadata 108_1 of the first bucket 112_1, in operation S704, the first worker container 106_1 may process the packet 101 indicated by the packet pointer 110 existing in the metadata 108_1 in the first bucket 112_1.

On the other hand, since the PIDs of the second to fourth worker containers 106_2 to 106_4 are not the same as the packet processing status bitmap (e.g., 300 of FIG. 3A) in the metadata 108_1 of the first bucket 112_1, the second to fourth worker containers 106_2 to 106_4 cannot process the packet 101 indicated by the packet pointer 110 existing in the metadata 108_1 in the first bucket 112_1.

In operation S706, information to be shared with other containers during packet processing may be recorded in the user data's own area, and when the first worker container 106_1 completes the processing of the corresponding packet, the first worker container 106_1 may set a bit 302-1 corresponding to itself in the packet processing status bitmap 300 existing in the metadata 108_1 as shown in FIG. 3B to 1, thereby displaying that packet processing has been completed.

Therefore, when the packet processing status bitmap 300 is modified as shown in FIG. 3B after the first worker container 106_1 processes the packet 101, the second and third worker containers 106_2 and 106_3 may process the packet 101 because the HD is 0x01.

In operation S708, when unnecessary worker containers are selected in advance due to packet characteristics, corresponding bits of the packet processing status bitmap 300 may be all set to 1.

For example, when a packet blocking flag is set to “1” and the corresponding packet is to be blocked without being processed by the fourth worker container 106_4, the bit 302_4 corresponding to the fourth worker container 106_4 among the bits 302_1 to 302_4 of the packet processing status bitmap 300 may be set to “1”.

In operation S710, the worker containers 106_1 to 106_4 may identify the packet processing status bitmap 300 to determine whether packet processing has been completed.

As shown in FIG. 3C, when all the bits 302_1 to 302_4 of the packet processing status bitmap 300 are set to 1 and the first to fourth worker containers 106_1 to 106_4 confirms that processing of the first packet 101 has been completed, in step S712, as shown in FIG. 4A, the corresponding bit 402_1 of the packet processing completion bitmap 400 may be set to 1 indicating the processing completion status.

For example, when the worker container that has confirmed that all the packet processing status bitmaps 300 are set to 1 is the fourth worker container 106_4, as shown in FIG. 4A, the fourth worker container 106_4 may set the corresponding bit 402_1 of the packet processing completion bitmap 400 to 1 indicating the processing completion status.

When the above process is repeated and all the packets indicated by the packet pointers of all metadata 108_1 to 108_10 in the first bucket 112_1 have been completely processed, the packet processing completion bitmap 400 may be set as shown in FIG. 4B.

Thereafter, the above process is repeated for the second bucket 112_2, which is the next bucket, so that the packets indicated by the packet pointers of the metadata in the second bucket 112_2 may be processed by the first to fourth worker containers 106_1 to 106_4.

As described above, according to the simultaneous packet processing system and method through multiple containers according to an embodiment of the disclosure, the plurality of worker containers may share buckets that store metadata indicating packets through a shared memory to distribute and process the packets simultaneously, and the plurality of containers may simultaneously process the packets in parallel to increase the throughput and significantly reduce the delay time.

Although the present disclosure has been described in detail through specific examples, it is intended to describe the present disclosure in detail, and the present invention is not limited thereto, and by those of ordinary skill in the art within the technical spirit of the present disclosure, it will be clear that the transformation or improvement is possible.

All simple modifications or changes of the present disclosure fall within the scope of the present disclosure, and the specific scope of protection of the present disclosure will be made clear by the appended claims.

What is claimed is:

1. A system for simultaneous packet processing through multiple containers, comprising:
a controller container configured to generate metadata comprising reference information on an input packet, generate a bucket, and store a plurality of pieces of metadata in the bucket;
a shared memory in which the bucket is generated; and
a plurality of worker containers configured to comprise each of modules constituting an application,
wherein each of the plurality of worker containers processes the packet by referring to the metadata in the bucket.

2. The system of claim 1, wherein the metadata comprises a packet processing status bitmap indicating whether the corresponding worker container processes the packet,
each bit of the packet processing status bitmap indicates a packet processing completion status or a packet non-processing status of the corresponding worker container,
the worker container having processed the packet sets the corresponding bit of the corresponding packet processing status bitmap to a packet processing completion status, and
the worker container having processed the packet sets, when a specific worker container does not need to process the packet, a bit corresponding to the specific worker container from the packet processing status bitmap for the corresponding packet to the packet processing completion status.

3. The system of claim 2, wherein each of the plurality of worker containers comprises:
a unique identification number (WID) of the worker container; and
a prerequisite worker container bitmask (PID) indicating that the corresponding worker container can process the packet after the corresponding packet is processed by the specific worker container.

4. The system of claim 3, wherein each of the worker containers:
simultaneously accesses the shared memory to refer to the bucket; and
confirms the packet to be processed by comparing the PID of each worker container with the packet processing status bitmap in the metadata of the bucket.

5. The system of claim 1, wherein a packet processing completion bitmap indicating whether each packet referred to by the metadata included in the bucket is completely processed is added to each bucket,
each bit of the packet processing completion bitmap indicates whether the packet referred to by the metadata included in the corresponding bucket is completely processed by all the worker containers, and
the worker container that has confirmed that all bits of the packet processing status bitmap are set to the packet processing completion status sets the corresponding bit of the packet processing completion bitmap to the packet processing completion status.

6. The system of claim 5, wherein, when all bits of the packet processing completion bitmap of the bucket are set to the packet processing completion state, the controller container empties or deletes the bucket, and
the controller container outputs or discards packets referred to by the metadata in the bucket according to a packet processing policy by referring to the metadata of the corresponding bucket in order to empty the corresponding bucket.

7. The system of claim 2, wherein the metadata further comprises:
a packet pointer configured to indicate a location of a packet stored in a storage space of a network interface card through which packets are input/output; and
user data including information shared with other containers during packet processing, including additional processing results for the packet.

8. The system of claim 1, wherein, when the number of buckets to store the generated metadata is insufficient, the controller container generates a new bucket for storing the generated metadata in the shared memory.

9. A method for simultaneous packet processing through multiple containers, the method comprising:
(A) by a controller container, generating metadata comprising reference information on an input packet;
(B) by the controller container, generating a bucket in a shared memory and storing a plurality of pieces of metadata in the bucket; and
(C) by each of a plurality of worker containers comprising each of modules constituting an application, processing the packet by referring to the metadata in the bucket.

10. The method of claim 9, wherein the metadata comprises a packet processing status bitmap indicating whether the corresponding worker container processes the packet,
each bit of the packet processing status bitmap indicates a packet processing completion status or a packet non-processing status of the corresponding worker container,
the worker container having processed the packet sets the corresponding bit of the corresponding packet processing status bitmap to the packet processing completion status, and
the worker container having processed the packet sets, when a specific worker container does not need to process the packet, a bit corresponding to the specific worker container from the packet processing status bitmap for the corresponding packet to the packet processing completion status.

11. The method of claim 10, wherein each of the plurality of worker containers comprises:
a unique identification number (WID) of the worker container; and
a prerequisite worker container bitmask (PID) indicating that the corresponding worker container can process the packet after the corresponding packet is processed by the specific worker container.

12. The method of claim 11, wherein each of the worker containers:
simultaneously accesses the shared memory to refer to the bucket; and
confirms the packet to be processed by comparing the PID of each worker container with the packet processing status bitmap in the metadata of the bucket.

13. The method of claim 9, wherein a packet processing completion bitmap indicating whether each packet referred to by the metadata included in the bucket is completely processed is added to each bucket,
each bit of the packet processing completion bitmap indicates whether the packet referred to by the metadata included in the corresponding bucket is completely processed by all the worker containers, and
the worker container that has confirmed that all bits of the packet processing status bitmap are set to the packet processing completion status sets the corresponding bit of the packet processing completion bitmap to the packet processing completion status.

14. The method of claim 13, wherein, when all bits of the packet processing completion bitmap of the bucket are set to the packet processing completion state, the controller container empties or deletes the bucket, and
the controller container outputs or discards packets referred to by the metadata in the bucket according to a packet processing policy by referring to the metadata of the corresponding bucket in order to empty the corresponding bucket.

15. The method of claim 10, wherein the metadata further comprises:
a packet pointer configured to indicate a location of a packet stored in a storage space of a network interface card through which packets are input/output; and
user data including information shared with other containers during packet processing, including additional processing results for the packet.

16. The method of claim 9, wherein, when the number of buckets to store the generated metadata is insufficient, the controller container generates a new bucket for storing the generated metadata in the shared memory.
